(19) United States
(12) Patent Application Publication
(10) Pub. No.: US 2015/0057480 A1
(43) Pub. Date: Feb. 26, 2015

(54) Radial Flow Process and Apparatus

(71) Applicant: UOP LLC, Des Plaines, IL (US)

(72) Inventors: Jeffrey R. Grott, Chicago, IL (US); David A. Wegerer, Lisle, IL (US); William Yanez, Crystal Lake, IL (US); Ka Lok, Buffalo Grove, IL (US)

(73) Assignee: UOP LLC, Des Plaines, IL (US)

(21) Appl. No.: 13/973,039

(22) Filed: Aug. 22, 2013

(51) Int. Cl. B01J 8/02

(52) U.S. Cl. CPC B01J 8/0214
USPC 585/415; 422/218; 208/134; 585/654

(57) ABSTRACT

A system for radial flow contact of a reactant stream with catalyst particles includes a reactor vessel and a catalyst retainer in the reactor vessel. The catalyst retainer includes an inner particle retention device and an outer particle retention device. The inner particle retention device and the outer particle retention device are spaced apart to define a catalyst retaining space. The inner particle retention device defines an axial flow path of the reactor vessel, and the outer particle retention device and an inner surface of a wall of the reactor vessel define an annular flow path of the reactor vessel. The system includes an inlet nozzle having an exit opening in fluid communication with the axial flow path, and an outlet nozzle in fluid communication with the annular flow path. The system can further include a fluid displacement device in the axial flow path of the reactor vessel.

### CROSS-REFERENCES TO RELATED APPLICATIONS

Not Applicable.

### STATEMENT REGARDING FEDERALLY SPONSORED RESEARCH

Not Applicable.

### BACKGROUND

1. Field of the Invention

The present invention relates generally to the contacting of fluids and particulate materials. Specifically, this invention relates to the internals of reactors used in the contact of fluids and solid particles. More specifically, this invention relates to the design of fluid displacement devices for use in conjunction with radial flow reactors and regenerators.

2. Description of the Related Art

A wide variety of industrial applications involve radial or horizontal flow apparatuses for contacting a fluid with a solid particulate. Representative processes include those used in the refining and petrochemical industries for hydrocarbon conversion, adsorption, and exhaust gas treatment. In reacting a hydrocarbon stream in a radial flow reactor, for example, the feed to be converted is normally at least partially vaporized when it is passed into a solid particulate catalyst bed to bring about the desired reaction. Over time, the catalyst gradually loses its activity, or becomes spent, due to the formation of coke deposits on the catalyst surface resulting from non-selective reactions and contaminants in the feed.

Moving bed reactor systems have therefore been developed for continuously or semi-continuously withdrawing the spent catalyst from the catalyst retention or contacting zone within the reactor and replacing it with fresh catalyst to maintain a required degree of overall catalyst activity. Typical examples are described in U.S. Pat. No. 3,647,680, U.S. Pat. No. 3,692,496, and U.S. Pat. No. 3,706,536. In addition, U.S. Pat. No. 3,978,150 describes a process in which particles of catalyst for the dehydrogenation of paraffins are moved continuously as a vertical column under gravity flow through one or more reactors having a horizontal flow of reactants. Another hydrocarbon conversion process using a radial flow reactor to contact an at least partially vaporized hydrocarbon reactant stream with a bed of solid catalyst particles is the reforming of naphtha boiling hydrocarbons to produce high octane gasoline. The process typically uses one or more reaction zones with catalyst particles entering the top of a first reactor, moving downwardly as a compact column under gravity flow, and being transported out of the first reactor. In many cases, a second reactor is located either underneath or next to the first reactor, such that catalyst particles move through the second reactor by gravity in the same manner. The catalyst particles may pass through additional reaction zones, normally serially, before being transported to a vessel for regeneration of the catalyst particles by the combustion of coke and other hydrocarbonaceous by-products that have accumulated on the catalyst particle surfaces during reaction.

The reactants in radial flow hydrocarbon conversion processes pass through each reaction zone, containing catalyst, in a substantially horizontal direction in the case of a vertically oriented cylindrical reactor. Often, the catalyst is retained in the annular zone between an outer particle retention device (e.g., an inlet screen) and an inner particle retention device (e.g., an outlet screen) in the forms of outer and inner cylinders, respectively. The devices form a flow path for the catalyst particles moving gradually downward via gravity, until they become spent and must be removed for regeneration. The devices also provide a way to distribute gas or liquid feeds to the catalyst bed and collect products at a common effluent collection zone. In the case of radial fluid flow toward the center of the reactor, for example, this collection zone may be a central, cylindrical space within the inner particle retention device. Regardless of whether the radial fluid flow is toward or away from the center, the passage of vapor is radially through one (outer or inner) retention device, the bed of catalyst particles, and through the second (inner or outer) retention device.

Radial flow reactor design typically requires that the volume upstream of the catalyst bed be minimized along with the reactor and piping pressure drop. Minimizing the volume upstream of the catalyst bed reduces the “hot volume” residence time, which is important for preventing the formation of side-products. Avoiding pressure drop across the reactor vessel is important for meeting process requirements both within the radial flow reactor and in downstream process units.

An additional concern for radial flow reactors is catalyst pinning. Experience has shown, that the horizontal flow of reactants through the bed of catalyst can interfere with the desired downward movement of catalyst particles for spent catalyst removal and regenerated catalyst introduction. Catalyst hang-up or pinning occurs, for example, when horizontally flowing vapor traps catalyst particles against the inner screen boundary of the reactor bed or catalyst retention zone, thereby impeding or preventing the downward movement of the pinned catalyst particles. Specifically, pinning increases frictional forces that counteract gravitational forces acting on the catalyst particles.

A typical radial flow reactor configuration includes a top inlet, inward radial flow reactor. For inward radial flow reactor designs, catalyst bed depth tends to be very narrow. Therefore, pinning of the catalyst against the wall of the catalyst particle retention devices is a concern.

A problem in the art, therefore, is how to balance the competing needs for good vapor distribution, avoiding pinning problems, minimizing hot residence time and minimizing pressure drop inside the reactor.

### SUMMARY

The aforementioned problems with radial flow reactor design may be solved through the use of a novel reactor design incorporating a top inlet nozzle and outward radial flow configuration with a plug inside the central conduit to minimize the hot volume residence time and reactor pressure drop, thereby improving process performance. An outward radial flow scheme also reduces problems with catalyst pinning, thereby allowing excellent continuous catalyst flow into and out of the reactor vessel. According to an aspect, a system for radial flow contact of a reactant stream with catalyst particles includes a reactor vessel, a catalyst retainer disposed in the reactor vessel. The catalyst retainer includes an inner particle retention device and an outer particle retention device. The inner particle retention device and the outer particle retention device are spaced apart to define a catalyst retaining space of the catalyst retainer. The inner particle retention device defines an axial flow path of the reactor vessel. The outer particle retention device and an inner surface of a wall of the reactor vessel define an annular flow path of the reactor vessel. An inlet nozzle has an exit opening in fluid communication with the axial flow path of the reactor vessel. An outlet nozzle is in fluid communication with the annular flow path of the reactor vessel.

According to an aspect, a system for radial flow contact of a reactant stream with catalyst particles includes a reactor vessel and a catalyst retainer disposed in the reactor vessel. The catalyst retainer includes an inner particle retention device and an outer particle retention device. The inner particle retention device and the outer particle retention device are spaced apart to define a catalyst retaining space of the catalyst retainer. The inner particle retention device defines an axial flow path of the reactor vessel. The outer particle retention device and an inner surface of a wall of the reactor vessel define an annular flow path of the reactor vessel. A fluid displacement device is positioned in the axial flow path of the reactor vessel.

A process for contacting a reactant stream with catalyst particles includes providing a reactor vessel and a catalyst retainer disposed in the reactor vessel. The catalyst retainer includes an inner particle retention device and an outer particle retention device. The inner particle retention device and the outer particle retention device are spaced apart to define a catalyst retaining space of the catalyst retainer. The inner particle retention device defining an axial flow path of the reactor vessel. The outer particle retention device and an inner surface of a wall of the reactor vessel define an annular flow path of the reactor vessel. The process further includes feeding a reactant stream into the axial flow path of the reactor vessel and diverting the reactant stream away from an axis of the axial flow path of the reactor vessel.

These and other features, aspects, and advantages of the present invention will become better understood upon consideration of the following detailed description, drawings and appended claims.

### BRIEF DESCRIPTION OF THE DRAWINGS

FIG. 1 is a cross-sectional profile of a typical top-inlet radial flow reactor with inward radial flow and having both outer and inner particle retention devices disposed therein and an annular catalyst bed between the devices.

FIG. 2 is a cross-sectional profile of a top-inlet radial flow reactor with outward radial flow and having a central conduit with a fluid displacement device disposed therein.

### DESCRIPTION

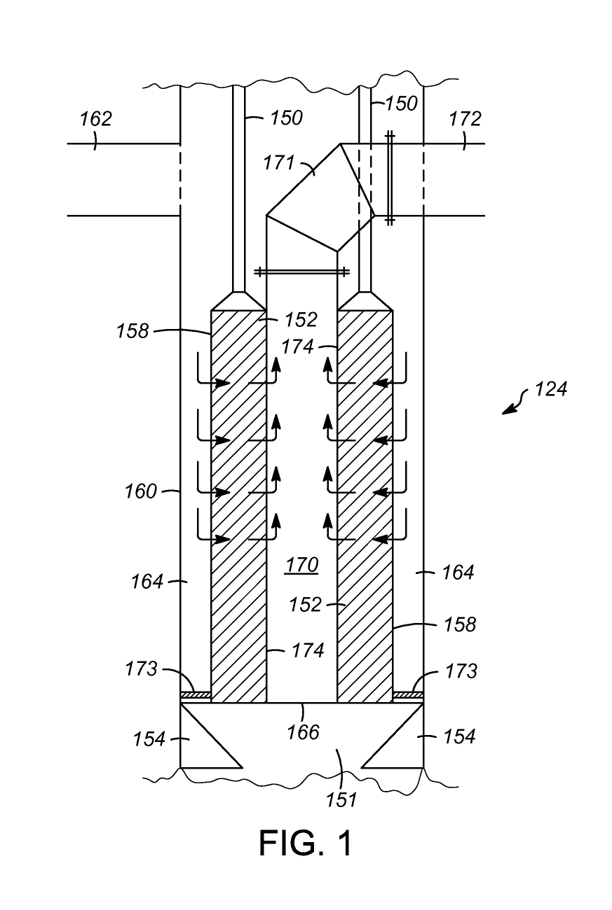

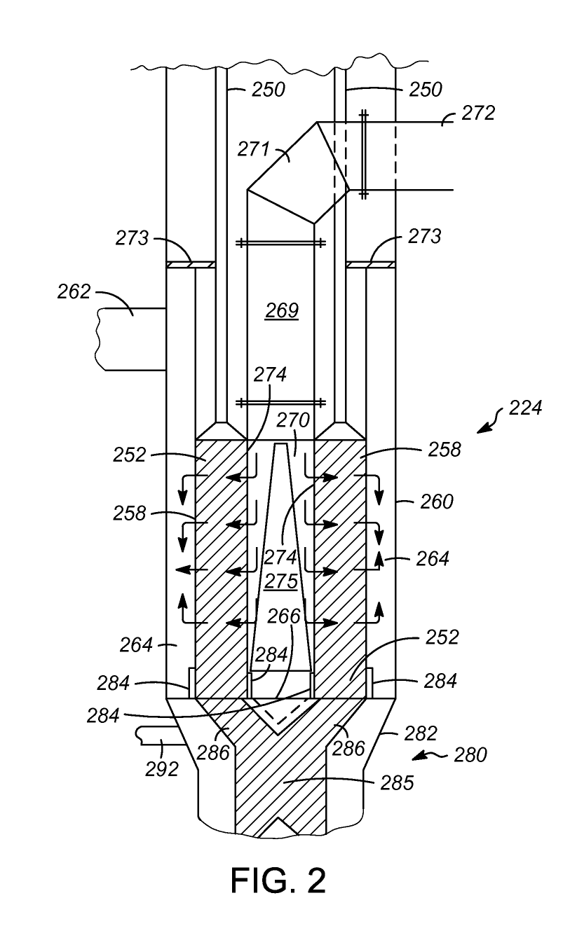

The features referred to in FIGS. 1-2 are not necessarily drawn to scale and should be understood to present an illustration of the invention and/or principles involved. Some features depicted have been enlarged or changed in view relative to others, in order to facilitate explanation and understanding. Particle retention devices such as screens, as well as radial flow fluid/solid contacting apparatuses and processes utilizing such apparatuses, as disclosed herein, will have configurations, components, and operating parameters determined, in part, by the intended application and also the environment in which they are used. The processes and apparatus described herein can be utilized in various hydrocarbon conversion processes. Some specific examples of hydrocarbon conversion processes are provided below.

In an example, the hydrocarbon conversion process is a reforming process. The reforming process is a common process in the refining of petroleum, and is usually used for increasing the amount of gasoline. The reforming process comprises mixing a stream of hydrogen and a hydrocarbon mixture and contacting the resulting stream with a reforming catalyst. The usual feedstock is a naphtha feedstock and generally has an initial boiling point of about 80° C. and an end boiling point of about 205° C. The reforming reactors are operated with a feed inlet temperature between 450° C. and 540° C. The reforming reaction converts paraffins and naphthenes through dehydrogenation and cyclization to aromatics. The dehydrogenation of paraffins can yield olefins, and the dehydrocyclization of paraffins and olefins can yield aromatics.

Reforming catalysts generally comprise a metal on a support. The support can include a porous material, such as an inorganic oxide or a molecular sieve, and a binder with a weight ratio from 1:99 to 99:1. The weight ratio is preferably from about 1:9 to about 9:1. Inorganic oxides used for support include, but are not limited to, alumina, magnesia, titania, zirconia, chromia, zinc oxide, thoria, boria, ceramic, porcelain, bauxite, silica, silica-alumina, silicon carbide, clays, crystalline zeolitic aluminasilicates, and mixtures thereof. Porous materials and binders are known in the art and are not presented in detail here. The metals preferably are one or more Group VIII noble metals, and include platinum, iridium, rhodium, and palladium. Typically, the catalyst contains an amount of the metal from about 0.01% to about 2% by weight, based on the total weight of the catalyst. The catalyst can also include a promoter element from Group IIIA or Group IVA. These metals include gallium, germanium, indium, tin, thallium and lead.

The hydrocarbon conversion process may be a dehydrocyclodimerization process wherein the feed comprises C2 to C6 aliphatic hydrocarbons which are converted to aromatics. Preferred feed components include C3 and C4 hydrocarbons such as isobutane, normal butane, isobutene, normal butene, propane and propylene. Diluents, e.g. nitrogen, helium, argon, and neon may also be included in the feed stream. Dehydrocyclodimerization operating conditions may include a reaction temperature from about 350° C. to about 650° C.; a pressure from about 0 kPa(g) to about 2068 kPa(g); and a liquid hourly space velocity from about 0.2 to about 5 hr-1. Preferred process conditions include a reaction temperature from about 400° C. to about 600° C.; a pressure from about 0 kPa(g) to about 1034 kPa(g); and a liquid hourly space velocity of from 0.5 to 3.0 hr-1. It is understood that, as the average carbon number of the feed increases, a reaction temperature in the lower end of the reaction temperature range is required for optimum performance and conversely, as the average carbon number of the feed decreases, the higher the required reaction temperature. Details of the dehydrocyclodimerization process are found for example in U.S. Pat. No. 4,654,455 and U.S. Pat. No. 4,746,763.

The dehydrocyclodimerization catalyst may be a dual functional catalyst containing acidic and dehydrogenation components. The acidic function is usually provided by a zeolite which promotes the oligomerization and aromatization reactions, while a non-noble metal component promotes the dehydrogenation function. Exemplary zeolites include ZSM-5, ZSM-8, ZSM-11, ZSM-12, and ZSM-35. One specific example of a catalyst disclosed in U.S. Pat. No. 4,746,763 consists of a ZSM-5 type zeolite, gallium and a phosphorus containing alumina as a binder. Multiple reactors or reaction zones may be used to manage the heat of reaction. The dehydrocyclodimerization process regeneration zone pressure may range from about 0 kPa(g) to about 103 kPa(g). In a particular embodiment, the regeneration conditions may include a step comprising exposing the catalyst to liquid water or water vapor as detailed in U.S. Pat. No. 6,657,096.

In an example, the hydrocarbon conversion process is a dehydrogenation process for the production of olefins from a feed comprising a paraffin. The feed may comprise C2 to C30 paraffinic hydrocarbons and in a preferred embodiment comprises C2 to C5 paraffins. General dehydrogenation process conditions include a pressure from about 0 kPa(g) to about 3500 kPa(g); a reaction temperature from about 480° C. to about 760° C.; a liquid hourly space velocity from about 1 to about 10 hr-1; and a hydrogen/hydrocarbon mole ratio from about 0.1:1 to about 10:1. Dehydrogenation conditions for C4 to C5 paraffin feeds may include a pressure from about 0 kPa(g) to about 500 kPa(g); a reaction temperature from about 540° C. to about 705° C.; a hydrogen/hydrocarbon mole ratio from about 0.1:1 to about 2:1; and an LHSV of less than 4. Additional details of dehydrogenation processes and catalyst may be found for example in U.S. Pat. No. 4,430,517 and U.S. Pat. No. 6,969,496.

Generally, the dehydrogenation catalyst comprises a platinum group component, an optional alkali metal component, and a porous inorganic carrier material. The catalyst may also contain promoter metals and a halogen component which improve the performance of the catalyst. In an embodiment, the porous carrier material is a refractory inorganic oxide. The porous carrier material may be an alumina with theta alumina being a preferred material. The platinum group includes palladium, rhodium, ruthenium, osmium and iridium and generally comprises from about 0.01 wt % to about 2 wt % of the final catalyst with the use of platinum being preferred. Potassium and lithium are preferred alkali metal components comprising from about 0.1 wt % to about 5 wt % of the final catalyst. The preferred promoter metal is tin in an amount such that the atomic ratio of tin to platinum is between about 1:1 and about 6:1. A more detailed description of the preparation of the carrier material and the addition of the platinum component and the tin component to the carrier material may be obtained by reference to U.S. Pat. No. 3,745,112. The dehydrogenation process regeneration zone pressure may range from about 0 kPa(g) to about 103 kPa(g).

Aspects of the invention relate to particle retention devices for use in apparatuses for contacting fluids (e.g., gases, liquids, or mixed phase fluids containing both gas and liquid fractions) with solids that are typically in particulate form (e.g., spheres, pellets, granules, etc.). The maximum dimension (e.g., diameter of a sphere or length of a pellet), for an average particle of such particulate solids, is typically in the range from about 0.5 mm (0.02 inches) to about 15 mm (0.59 inches), and often from about 1 mm (0.04 inches) to about 10 mm (0.39 inches). An exemplary solid particulate is a catalyst used to promote a desired hydrocarbon conversion reaction and normally containing a catalytically active metal or combination of metals dispersed on a solid, microporous carrier as described above. Catalysts and other solid particulates are retained in particle retention devices when the smallest widths of the flow channels, for passage of fluid in the radial direction, are less than the smallest dimension (e.g., diameter of a sphere or diameter of the base of a pellet), for an average particle of a particulate solid. Typical smallest or minimum flow channel widths (e.g., formed as gaps or openings between adjacent, spaced apart profile wires or windings of profile wires) are in the range from about 0.3 mm (0.01 inches) to about 5 mm (0.20 inches), and often from about 0.5 mm (0.02 inches) to about 3 mm (0.12 inches). A representative apparatus containing a particle retention device according to the present invention is therefore a radial flow reactor that may be used in a number of chemical reactions including hydrocarbon conversion reactions such as catalytic dehydrogenation and catalytic reforming.

Use of the term “particle retention device” is understood to refer to devices that retain, or restrict the flow of, a solid particulate in at least one direction (e.g., radially), but do not necessarily immobilize the solid particulate. In fact, contemplated applications of the particle retention devices include their use in radial flow reactors in which the solid particulate, often a catalyst used to promote a desired conversion, is in a moving bed that allows the catalyst to be intermittently or continuously withdrawn (e.g., for regeneration by burning accumulated coke) and replaced in order to maintain a desired level of catalytic activity in the reactor. Therefore, the particle retention device may, for example, confine the catalyst in the radial direction (e.g., from the center of the reactor to an outer radius of a cylindrical retention zone or otherwise between an inner radius and an outer radius of an annular retention zone) but still allow the catalyst to move axially in the downward direction.

If only a single particle retention device is employed, the choice of an outer particle retention device or an inner particle retention device will often depend on the whether the radial or horizontal fluid flow to the catalyst or other solid particulate is directed toward or away from the central axis of the cylindrical vessel of the reactor or other contacting apparatus. If the fluid flow is toward the central axis, it will normally be desired to use at least an outer particle retention device, while at least an inner particle retention device is usually more appropriate in the case of fluid flow away from the central axis. In this manner, the radial fluid flow entering the bed of catalyst or other solid particulate will first pass through flow channels of the particle retention device as described herein for effective (i) fluid distribution of the inlet fluid (e.g., a hydrocarbon-containing feed stream) and (ii) reduction in the propensity for this inlet fluid to form fluid jets with high localized velocities that impinge on the catalyst or other solid particulate.

As discussed above, however, the use of both outer and inner particle retention devices can be advantageous for not only distributing the inlet fluid such as a hydrocarbon-containing feed stream to, but also for collecting the outlet fluid such as a hydrocarbon-containing product stream as it exits the particle retention zone from, the particle retention zone. Particle retention devices described herein can also be combined with conventional screens, for example, in the case of radial fluid flow toward the central axis of the vessel, an outer particle retention device as described herein may be used to effectively distribute the inlet fluid feed, and a conventional inner screen may be used to collect outlet fluid product, whereby solid particulate is retained in an annular particle retention zone between the outer particle retention device and the screen.

Representative embodiments of the invention are directed to radial flow reactors, including moving bed reactors, comprising a vessel, a particle retention device, and a fluid displacement device, as described herein, that is disposed in the vessel to promote the desired fluid/solid particulate contacting. In many cases, the vessel, particle retention device, and fluid displacement device, will have a circular cross-section, with the vessel, particle retention device, and fluid displacement device being positioned concentrically, and often with their common axes extending vertically. Other vessel geometries for the vessel and/or particle retention device and/or fluid displacement device, for example conical, or cylindrical with one or more conical ends, are possible. The fluid displacement devices may also be used in reactors having cross-sectional shapes that are not circular, for example elliptical or polygonal. Normally, the cross-sectional shapes of the vessel, particle retention device and fluid displacement device will be the same (although varied in size) at any common axial position within the vessel, in order to promote radial flow uniformity.

Referring now to the Figures, like elements are indicated with like numbers between FIGS. 1-2 with the 100 series elements of FIG. 1 analogous to the 200 series elements of FIG. 2. For example, central conduit 170 in FIG. 1 is analogous to central conduit 270 in FIG. 2, etc. Certain exceptions to the aforementioned numbering scheme are specifically noted where elements may not be analogous.

FIG. 1 shows a sectional view of a typical top-inlet inward radial flow reactor. An understanding of the construction and operation of a typical top-inlet inward radial flow reactor provides context and motivation for the novel radial flow reactor of the present invention. Catalyst particles (not shown) are transferred by a series of transfer conduits 150 into a particle retaining space 152 in the interior space of the vessel 124. A bed of catalyst particles is formed in retaining space 152 immediately below the lower extent of transfer conduits 150. A vessel partition 154 defines a catalyst collection space 151 below the lower extent of retaining space 152 and the catalyst bed. An inner particle retention device 174 and an outer particle retention device 158 define the extent of the catalyst bed in retaining space 152, which has a generally annular cross section. Catalyst particles are withdrawn from the bottom of retaining space 152 into the catalyst collection space 151 and then through another series of transfer conduits (not shown) that transfer the catalyst particles from the vessel 124.

The reactant stream enters the vessel 124 through a nozzle 162 and flows into an outer chamber 164 defined by an interior surface of the outer wall 160 of the vessel 124 and an exterior surface of the outer particle retention device 158. A base plate 166 extends across the bottom of chamber 164 to separate it from the catalyst collection space 151. Chamber 164 communicates the reactants with the interior of the retaining space 152 through the outer particle retention device 158. The reactants pass across retaining space 152, through the inner particle retention device 174, and are collected by a central conduit 170 defined by the interior space of the inner particle retention device. Central conduit 170 has a closed bottom and transports the effluent vapors from retaining space 152 upward and out of the vessel 124 through a nozzle 172 via elbow connector 171. The inlet nozzle 162 and outlet nozzle 172 are at the same elevation.

Means are provided for supporting the particle retention devices 158 and 174 in place within the vessel 124. Based on the configuration of a typical top-inlet inward radial flow reactor, the particle retention devices 158 and 174 are supported from the bottom. For example, in FIG. 1, a support 173 positioned near the bottom of the vessel 124 contacts the lower end of the outer particle retention device 158 in order to hold the outer particle retention device 158 in place.

Flow arrows in the Figures illustrate radial fluid flow through inner and outer particle retention devices (e.g., 174, 158 in FIG. 1), and also through catalyst particle retaining space (e.g., 152 in FIG. 1), but an overall upward flow of feed distributed to, and product collected from, the particle retaining space (e.g., 152 in FIG. 1).

FIG. 2 shows a sectional view of an embodiment of the top-inlet outward radial flow reactor of the present invention. The construction and operation of the top-inlet outward radial flow reactor of FIG. 2 share several similarities with the top-inlet inward radial flow reactor depicted in FIG. 1. For example, catalyst particles are transferred by a series of transfer conduits 250 into a particle retaining space 252 in the interior space of the vessel 224. A bed of catalyst particles is formed in retaining space 252 immediately below the lower extent of transfer conduits 250. An inner particle retention device 274 and an outer particle retention device 258 define the extent of the catalyst bed in retaining space 252, which has a generally annular cross section.

Catalyst particles are withdrawn from the bottom of retaining space 252 into an integral catalyst collector 280 having an outer wall 282 and connectors 284 for connecting to the vessel 224. A main conduit 285 is in communication with transfer conduits 286 of the catalyst collector 280 that transfer the catalyst particles from the retaining space 252 of the vessel 224. Catalyst exits the main conduit 285 at a nozzle. A purge gas inlet nozzle 292 is in fluid communication with the catalyst collector 280.

The differences between the vessels 124 and 224 of FIGS. 1 and 2, respectively, include, among other things, the location and elevation of the inlet and outlet nozzles, the design of supports for the particle retention devices, and the inclusion of a fluid displacement device. Referring again to FIG. 2, the reactant stream enters the vessel 224 through a nozzle 272. The reactant stream passes from the nozzle 272 into the central conduit 270 via elbow connector 271 and intermediate conduit 269. The central conduit 270 is defined by the interior space of the inner particle retention device.

The conduit 270 communicates the reactants with the interior of the retaining space 252 through the inner particle retention device 274. The reactants pass across the retaining space 252, through the outer particle retention device 258, and are collected in an outer chamber 264, which is defined by an interior surface of the outer wall 260 of the vessel 224 and an exterior surface of the outer particle retention device 258. Outer chamber 264 transports the effluent vapors from retaining space 252 and out of the vessel 224 through a nozzle 262. The outer particle retention device 258 has a controlled pressure drop/vapor distribution effect. The outer particle retention device 258 can be designed with a pressure drop of between about 350 Pa (0.05 psi) to 35,000 Pa (5.0 psi) greater than the axial friction loss in the conduit 270 pressure drop in an example. The pressure drop may be greater than the axial friction loss in the conduit 270 pressure drop of between about 350 Pa (0.05 psi) to 20,500 Pa (3.0 psi) in another example, between about 7000 Pa (1.0 psi) and about 35,000 Pa (5.0 psi) in another example, between about 7000 Pa (1.0 psi) and about 20,500 Pa (3.0 psi) in another example, between about 350 Pa (0.05 psi) and about 7000 Pa (1.0 psi) in another example, and between about 350 Pa (0.05 psi) and about 3500 Pa (0.50 psi) in yet another example.

Another difference between the radial flow reactor of FIG. 1 and the radial flow reactor of FIG. 2 is the inlet nozzle 272 is positioned at a higher elevation than the outlet nozzle 262. The outlet nozzle 262 may be positioned above the catalyst retaining space 252, as illustrated in FIG. 2, or lower at a position generally adjacent to the catalyst retaining space. Means are provided for supporting the particle retention devices 258 and 274 in place within the vessel 224. However, based on the configuration of the inlet nozzle 272 and the outlet nozzle 262 of a top-inlet outward radial flow reactor of the present invention, the particle retention devices 258 and 274 may be supported from the top. For example, in FIG. 2, a support 273 positioned near the top of the vessel 224 contacts the upper end of the outer particle retention device 258 in order to hold the outer particle retention device 258 in place.

For radial flow reactors, and particularly in reforming reactors, it is usually desirable to limit pressure drop across the vessel 124, 224. Furthermore, in fluid particle contacting in general, it is preferred to avoid excessive pressure drop through fluid distributors. For example, it is known in the art that appreciable pressure drops will form fluid jets that can impinge upon and damage the contacted particles. A key element of the top-inlet outward radial flow reactor design is the placement of a fluid displacement device 275 situated within the central conduit 270. A suitable fluid displacement device 275 may have a frustoconical shape as depicted in FIG. 2. The fluid displacement device 275 may be situated such that the cross-sectional area of the central conduit 270 decreases in the axial direction progressing away from the inlet nozzle 272.

One advantage of a frustoconical fluid displacement device 275 is the ability to operate the reactor 224 with a substantially constant linear velocity of the reactant stream across the catalyst retaining space 252. In the absence of the fluid displacement device 275, the outward (radial) linear velocity decreases in the axial direction as the reactant stream flows towards the bottom of the central conduit 270. However, with the fluid displacement device 275 in place, the volume of the flow path traveled by the reactant stream decreases in the axial direction effective resulting in a more constant linear velocity in the radial flow direction.

Further advantages of the design and operation of the vessel 224 of FIG. 2 result from the outward radial flow of the reactant stream. First, as the volume that may be occupied by the reactant stream increases in the outward radial direction, the linear flow rate of the reactant stream is lower at the surface of the outer particle retention device 258 as compared with the surface of the inner particle retention device 274. Therefore, potential issues with catalyst pinning are alleviated as compared with an inward radial flow reactor design. Furthermore, catalyst particles will collide with the particle retention device in the direction of flow of the reactant stream. For inward radial flow, catalyst particles collide more frequently with the surface of the inner particle retention device 274. However, for outward radial flow, as the surface area of the outer particle retention device 258 is greater than the surface area of the inner particle retention device 274, wear and tear due to catalyst particles colliding with the surface of the outer particle retention device is distributed over a greater area, thereby increasing the amount of time the vessel 224 may be operated before maintenance is required.

Yet another advantage of the fluid displacement device 275 is that volume of the central conduit 270 is reduced, thereby minimizing the volume upstream of the catalyst bed and reducing the “hot volume” residence time. By decreasing the volume upstream of the catalyst bed, the residence time of the reactant stream in the vessel 224 in which the reactant stream is not in contact with catalyst particles is reduced. In turn, the extent of formation of undesirable side-products is also reduced. Overall, aspects of the invention are associated with fluid displacement devices for use in radial flow reactors and regenerators.

While use of the radial flow apparatus is not limited to any process, the radial flow apparatus can be particularly beneficial in: (i) the catalytic reforming of a hydrocarbon feedstream (e.g., a naphtha feedstream) to produce aromatics (e.g., benzene, toluene and xylenes) (see, e.g., U.S. Patent Application Publication Nos. 2012/0277501, 2012/0277502, 2012/0277503, 2012/0277504, and 2012/0277505); (ii) high temperature reforming (see U.S. Patent Application Publication No. 2012/0275974); (iii) the conversion of liquid petroleum gas (LPG) into liquid aromatics (e.g., the UOP Cyclar™ process); and (iv) the catalytic dehydrogenation of a paraffin stream to yield olefins (see, e.g., U.S. Pat. No. 8,282,887).

Those having skill in the art, with the knowledge gained from the present disclosure, will recognize that various changes could be made in the above devices, as well as radial flow fluid/solid contacting apparatuses and processes utilizing these devices, without departing from the scope of the present disclosure. Therefore, the scope of the appended claims should not be limited to the description of the embodiments contained herein.

1. A system for radial flow contact of a reactant stream with catalyst particles, the system comprising:
a reactor vessel;
a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel;
an inlet nozzle having an exit opening in fluid communication with the axial flow path of the reactor vessel; and
an outlet nozzle in fluid communication with the annular flow path of the reactor vessel.

2. The system of claim 1, further comprising a fluid displacement device disposed in the axial flow path of the reactor vessel.

3. The system of claim 2, wherein the fluid displacement device has a frustoconical surface.

4. The system of claim 2, wherein a transverse cross-sectional area of the fluid displacement device increases along the axial flow path of the reactor vessel.

5. The system of claim 1, wherein the outer particle retention device is supported from an upper end of the outer particle retention device.

6. The system of claim 1, wherein the inlet nozzle is in fluid communication with a source of the reactant stream.

7. The system of claim 1, wherein a single inlet nozzle is in fluid communication with the axial flow path of the reactor vessel.

8. The system of claim 1, wherein the inlet nozzle is at a higher elevation than the outlet nozzle.

9. The system of claim 1, wherein the outlet nozzle is positioned above the catalyst retaining space.

10. The system of claim 1, further comprising an integral catalyst collector.

11. A system for radial flow contact of a reactant stream with catalyst particles, the system comprising:
a reactor vessel;
a catalyst retainer disposed in the reactor vessel, the catalyst retainer including an inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel; and
a fluid displacement device positioned in the axial flow path of the reactor vessel.

12. The system of claim 11 wherein:
the system includes an inlet nozzle having an exit opening in fluid communication with the axial flow path of the reactor vessel; and
the fluid displacement device is downstream of the exit opening of the inlet nozzle.

13. The system of claim 11, wherein an outer surface of the fluid displacement device and the inner screen define a converging flow path between the outer surface of the fluid displacement device and the inner screen.

14. The system of claim 11, wherein the fluid displacement device has a frustoconical surface.

15. The system of claim 11, wherein the outer particle retention device is supported from an upper end of the outer particle retention device.

16. The system of claim 11, wherein the inlet nozzle is in fluid communication with a source of the reactant stream.

17. The system of claim 11, wherein the inlet nozzle is at a higher elevation than the outlet nozzle.

18. A process for contacting of a reactant stream with catalyst particles, the process comprising:
(a) providing a reactor vessel and a catalyst retainer disposed in the reactor vessel, the catalyst retainer including a inner particle retention device and an outer particle retention device, the inner particle retention device and the outer particle retention device being spaced apart to define a catalyst retaining space of the catalyst retainer, the inner particle retention device defining an axial flow path of the reactor vessel, the outer particle retention device and an inner surface of a wall of the reactor vessel defining an annular flow path of the reactor vessel;
(b) feeding a reactant stream into the axial flow path of the reactor vessel; and
(c) diverting the reactant stream away from an axis of the axial flow path of the reactor vessel.

19. The process of claim 18, further comprising providing a fluid displacement device having a frustoconical surface disposed in the axial flow path of the reactor vessel for diverting the reactant stream away from an axis of the axial flow path of the reactor vessel.

20. The process of claim 18, wherein the reactant stream has a pressure drop of approximately 350 Pa to 35,000 Pa greater than an axial frictional loss pressure drop along the axial flow path after passing through the catalyst retainer.
